(19) United States
(12) Patent Application Publication
(10) Pub. No.: US 2016/0089630 A1
(43) Pub. Date: Mar. 31, 2016

(54) VACUUM FORELINE REAGENT ADDITION FOR FLUORINE ABATEMENT

(71) Applicant: Applied Materials, Inc., Santa Clara, CA (US)

(72) Inventors: Colin John DICKINSON, San Jose, CA (US); Dustin W. HO, Santa Clara, CA (US); Monique MCINTOSH, San Jose, CA (US)

(21) Appl. No.: 14/838,408

(22) Filed: Aug. 28, 2015

Related U.S. Application Data
(60) Provisional application No. 62/072,205, filed on Oct. 29, 2014.
(60) Provisional application No. 62/055,092, filed on Sep. 25, 2014.

(51) Int. Cl. B01D 53/68; B01D 53/77

(52) U.S. Cl. CPC B01D 53/68; B01D 53/77; B01D 2257/2066

(57) ABSTRACT

Embodiments disclosed herein include an abatement system for abating compounds produced in semiconductor processes. The abatement system includes a foreline having a first end configured to couple to an exhaust port of a vacuum processing chamber, and an injection port is formed in the foreline. The abatement system further includes a scrubber coupled to a second end of the foreline. There is no effluent burner or plasma source interfaced with the foreline between the first end and the scrubber. Low temperature steam is injected into the foreline through the injection port to abate the PFCs flowing out of the vacuum processing chamber.

### CROSS-REFERENCE TO RELATED APPLICATIONS

This application claims priority to U.S. Provisional Patent Application Ser. No. 62/055,092, filed on Sep. 25, 2014, and to U.S. Provisional Patent Application Ser. No. 62/072,205, filed on Oct. 29, 2014, which herein are incorporated by reference.

### BACKGROUND

1. Field

Embodiments of the present disclosure generally relate to semiconductor processing equipment. More particularly, embodiments of the present disclosure relate to an abatement system and a vacuum processing system for abating compounds produced in semiconductor processes.

2. Description of the Related Art

The process gases used by semiconductor processing facilities include many compounds which must be abated or treated before disposal, due to regulatory requirements and environmental and safety concerns. Among these compounds are perfluorocarbons (PFCs) or halogen containing compounds, which are used, for example, in a cleaning process following chemical vapor deposition (CVD) processes.

Typically, a remote plasma source or an effluent burner may be used to abate the PFCs or halogen containing compounds, and the remote plasma source or the heating source requires large amount of energy to operate. Accordingly, what is needed in the art is an improved abatement system and vacuum processing system for abating compounds produced in semiconductor processes.

### SUMMARY

Embodiments disclosed herein include an abatement system for abating compounds produced in semiconductor processes. In one embodiment, an abatement system is disclosed. The abatement system includes a foreline having a first end configured to couple to an exhaust port of a vacuum processing chamber, and an injection port is formed in the foreline. The abatement system further includes a scrubber coupled to a second end the foreline. There is no effluent burner or plasma source interfaced with the abatement system between the first end and second end of the foreline.

In another embodiment, a method includes maintaining a hydrogen containing compound in a low pressure boiler at a temperature that is less than a boiling point of the hydrogen containing compound at 760 Torr, reducing a pressure in the low pressure boiler to form a vapor, flowing the vapor into a foreline via an injection port, and reacting the vapor with halogen containing compounds in the foreline. The halogen containing compounds are not heated or flowed into a plasma source.

In another embodiment, a method includes signaling a controller that a halogen containing gas is flowing into a vacuum processing chamber or a remote plasma source coupled upstream of the vacuum processing chamber by a chamber controller, signaling the controller that the remote plasma source is operating by the chamber controller, and opening one or more valves to inject an abating agent into a foreline via an injection port by the controller.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 schematically illustrates a vacuum processing chamber and an abatement system.

### DETAILED DESCRIPTION

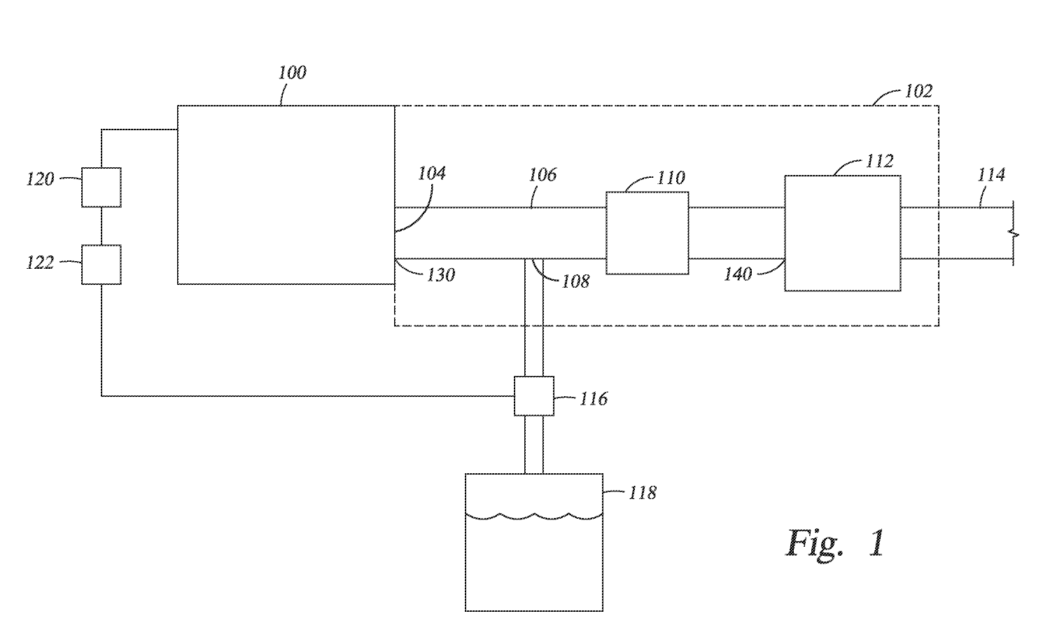

FIG. 1 schematically illustrates a vacuum processing chamber 100 and an abatement system 102. The vacuum processing chamber 100 is generally configured to perform at least one integrated circuit manufacturing process, such as a deposition process, a clean process, an etch process, a plasma treatment process, a preclean process, an ion implant process, or other integrated circuit manufacturing process. The process performed in the vacuum processing chamber 100 may be plasma assisted. For example, the process performed in the vacuum processing chamber 100 may be plasma deposition process for depositing a silicon-based material. In one embodiment, the vacuum processing chamber 100 is a plasma enhanced chemical vapor deposition chamber.

The vacuum processing chamber 100 has a chamber exhaust port 104 coupled to a foreline 106 of the abatement system 102. A throttle valve (not shown) may be placed proximate the chamber exhaust port 104 for controlling the pressure inside the vacuum processing chamber 100.

The foreline 106 of the abatement system 102 has a first end 130 configured to couple to the exhaust port 104 of a vacuum processing chamber 100. An injection port 108 is formed in the foreline 106. The abatement system 102 further includes a scrubber 112 coupled to a second end 140 the foreline 106. A vacuum pump 110 is coupled to the foreline 106 at a location between the injection port 108 and the scrubber 112. There is no effluent burner or plasma source interfaced with the abatement system 102 between the first end 130 and second end 140 of the foreline 106. Stated in another manner, there is no effluent burner or plasma source interface with the foreline 106 between the chamber exhaust port 104 and the scrubber 112.

The injection port 108 formed in the foreline 106 is utilized for introducing an abating agent into the foreline 106. The injection port 108 may be connected to a abating agent delivery system 118 containing the abating agent, and one or more valves 116 may be placed between the abating agent delivery system 118 and the injection port 108 to control the flow of the abating agent. For example, the valves 116 between the abating agent delivery system 118 and the injection port 108 may include an isolation valve and a needle valve. The abating agent may be any hydrogen containing compound, such as water or hydrogen gas. In one embodiment, the abating agent delivery system 118 is a low pressure boiler, and a liquid abating agent, such as liquid water, is disposed in the low pressure boiler. An abating agent in the form of a vapor is injected into the foreline 106 via the injection port 108. In order to turn the liquid abating agent into a vapor abating agent without consuming large amount of energy, the low pressure boiler may be fluidly coupled to the foreline 106 such that the vacuum within the foreline 106 reduces the pressure inside the low pressure boiler to a level that cause the water (or other liquid abating agent) within the low pressure boiler to boil (i.e., produce a vapor) with little or no heating of the fluid within the low pressure boiler. For example, at the reduced pressure, such as between 15 to 40 Torr, caused by fluidly coupling the interior of the low pressure boiler to the foreline 106, water boils at a temperature that is less than about 100 degrees Celsius, such as between about 15 degrees Celsius and about 40 degrees Celsius. Thus, water or other abating agent inside the abating agent delivery system may be maintained at a temperature that is less than the boiling point of water or other abating agent at atmospheric pressure (760 Torr). When the one or more valves 116 are open, the pressure inside the low pressure boiler is reduced, which reduces the boiling point of the liquid water disposed inside the low pressure boiler. In one embodiment, the liquid water is maintained at about 35 degrees Celsius, and the low pressure in the low pressure boiler created by the vacuum pump 110 coupled to the foreline 106 causes the liquid water to vaporize at less than 100 degrees Celsius, for example less than about 40 degrees Celsius, such as about 35 degrees Celsius. The water vapor injected into the foreline 106 is at a temperature of much less than less than 100 degrees Celsius, for example less than about 40 degrees Celsius, such as about 35 degrees Celsius. Alternatively, the abating agent delivery system 118 may be a flash evaporator capable of turning liquid water into water vapor. The pressure inside the abating agent delivery system 118 may range from about 15 Torr to about 760 Torr, depending on the type of the abating agent delivery system 118 is used. A level sensor (not shown) may be located in the abating agent delivery system 118 for providing a signal to a controller 122 what selectively opens a fill valve (not shown) to maintain the water level inside the abating agent delivery system 118.

The flow rate of the abating agent flowing into the foreline 106 may depend on the amount of PFCs or halogen containing compounds formed in the vacuum processing chamber. In one embodiment, the abating agent has a flow rate of about 1 to 10 standard liters per minute (slm), such as 1 to 3 slm. The flow rate of the abating agent may be controlled by operation of the one or more valves 116. The one or more valves 116 may be any suitable valves for controlling the flow of the abating agent. In one embodiment, the one or more valves 116 include a needle valve for fine tuning the control of the flow of the abating agent.

The abating agent, such as water vapor, injected into the foreline reacts with the halogen containing compounds, such as atomic fluorine and/or fluorine molecules, or atomic chlorine and/or chlorine molecules, to form a more environmentally and/or process equipment friendly composition, such as HF and oxygen gas or HCl and oxygen gas. The more environmentally and/or process equipment friendly composition flows down the foreline 106 and into the scrubber 112. The scrubber 112 may be coupled to the foreline 106 downstream of the vacuum pump 110. The scrubber 112 may be any suitable scrubber and may further remove and/or neutralize atomic fluorine and/or fluorine molecules. The product exiting the scrubber 112 is then directed to the facility exhaust (not shown) via the exhaust line 114.

It has been surprisingly discovered that a hydrogen-containing abating agent, such as water vapor, can react with atomic fluorine and/or fluorine molecules or atomic chlorine and/or chlorine molecules in the foreline 106 to form a more environmentally and/or process equipment friendly composition, such as HF and oxygen gas or HCl and oxygen gas without the need for energy consuming plasma sources and/or effluent burners. Thus, there is no need for a plasma source or effluent burner disposed in-line with the foreline to abate the fluorine/chlorine atoms and/or molecules, which reduces the cost of abating the fluorine/chlorine atoms and/or molecules by eliminating the amount of energy needed to operate the plasma source or the effluent burner.

To further reduce the cost of the abatement process, the abating agent may be injected into the foreline 106 when halogen containing compounds such as fluorine/chlorine atoms and/or molecules are present in the foreline 106, and the abating agent injection may be discontinued when there are no halogen containing compounds in the foreline 106. This can be achieved by connecting the controller 122 to the one or more valves 116 and to a chamber controller 120, which is connected to the vacuum processing chamber 100. In one embodiment, the chamber controller 120 and the controller 122 communicate to allow the controller 122 to determine when a halogen containing gas is flowing into the vacuum processing chamber 100 or a remote plasma source coupled to the vacuum processing chamber 100 and upstream of the vacuum processing chamber 100. In addition, the chamber controller 120 and the controller 122 communicate to allow the controller 122 to determine when the remote plasma source located upstream of the vacuum processing chamber 100 is operating. In response to determining that the chamber controller 120 is providing halogen containing gas into the processing chamber directly or indirectly, the controller 122 may outputs a signal to open the one or more valves 116 to inject the abating agent, such as water vapor, into the foreline 106 from the abating agent delivery system 118. Thus, the abating agent is injected into the foreline 106 when there are materials that need to be abated in the foreline 106, and is not injected into the foreline 106 when there are no materials that need to be abated in the foreline 106, which conserves energy and resources, such as water.

An abatement system without a plasma or an effluent burner may be used to abate halogen containing compounds formed in a vacuum processing chamber during semiconductor processes. The abatement system includes a foreline, an injection port formed in the foreline, and a scrubber. The abatement system may also include the abating agent delivery system. By injecting an abating agent into the foreline via the injection port, halogen containing compounds in the foreline are converted to a more environmental and/or process equipment friendly composition. By excluding a plasma or an effluent burner, less energy is needed for the abatement process, which leads to a reduction in cost for the abatement process.

Although the system and methods described above are described in the context of abating PFCs or halogen containing compounds, it is contemplated that the abatement system may be adapted to treat effluent comprised of other components that are undesirable for release.

While the foregoing is directed to embodiments of the present disclosure, other and further embodiments may be devised without departing from the basic scope thereof, and the scope thereof is determined by the claims that follow.

What is claimed is:

1. An abatement system, comprising:
a foreline having a first end configured to couple to an exhaust port of a vacuum processing chamber, wherein an injection port is formed in the foreline; and
a scrubber coupled to a second end of the foreline, wherein there is no effluent burner or plasma source interfaced with the foreline between the first end and the scrubber.

2. The abatement system of claim 1 further comprising:
an abating agent delivery system coupled to the injection port.

3. The abatement system of claim 2, wherein the abating agent delivery system is a low pressure boiler.

4. The abatement system of claim 3, wherein the low pressure boiler is operable to produce steam in response to a reduction of pressure within the low pressure boiler caused by fluidly coupling an interior of the low pressure boiler to an environment of the foreline.

5. The abatement system of claim 2, further comprising one or more valves disposed between the abating agent delivery system and the injection port.

6. The abatement system of claim 1, further comprising a vacuum pump disposed between the injection port and the scrubber.

7. The abatement system of claim 1, wherein the vacuum processing chamber is a plasma enhanced chemical vapor deposition chamber.

8. A method, comprising:
maintaining a hydrogen containing compound in a low pressure boiler at a temperature that is less than a boiling point of the hydrogen containing compound at 760 Torr;
reducing a pressure in the low pressure boiler to form a vapor of the hydrogen containing compound;
flowing the vapor into a foreline via an injection port; and
reacting the vapor with halogen containing compounds in the foreline, wherein the halogen containing compounds are not heated or flowed into a plasma source.

9. The method of claim 8, wherein the hydrogen containing compound is liquid water.

10. The method of claim 9, wherein the temperature of the low pressure boiler is maintained at less than about 100 degrees Celsius.

11. The method of claim 10, wherein the vapor is water vapor.

12. The method of claim 8, wherein the foreline has a first end and a second end, the first end is configured to couple to an exhaust port of a vacuum processing chamber, and the second end is configured to couple to a scrubber.

13. The method of claim 12, wherein the reducing the pressure in the low pressure boiler is achieved by a vacuum pump disposed between the injection port and the scrubber.

14. The method of claim 9, wherein the hydrogen containing compound is maintained at about 15 to 40 degrees Celsius.

15. The method of claim 14, wherein the pressure in the low pressure boiler is reduced to about 15 Torr to 40 Torr.

16. The method of claim 8, wherein the vapor is flowed into the foreline at a rate of about 1 to 10 standard liters per minute.

17. A method, comprising:
signaling a controller that a halogen containing gas is flowing into a vacuum processing chamber or a remote plasma source coupled upstream of the vacuum processing chamber by a chamber controller;
signaling the controller that the remote plasma source is operating by the chamber controller; and
opening one or more valves to inject an abating agent into a foreline via an injection port by the controller.

18. The method of claim 17, wherein the halogen containing gas is a fluorine containing gas.

19. The method of claim 17, wherein the abating agent is a hydrogen containing compound.

20. The method of claim 19, wherein the abating agent is water vapor.
